(19) United States
(12) Patent Application Publication
(10) Pub. No.: US 2023/0182133 A1
(43) Pub. Date: Jun. 15, 2023

(54) SYSTEMS AND METHODS FOR PROCESSING AND TESTING BIOLOGICAL SAMPLES

(71) Applicant: GRAPHENE-DX. INC., Boston, MA (US)

(72) Inventors: Tom RUBY, Boston, MA (US); Stephen PIZZO, Brookline, MA (US); Kyle BULLOCH, Rancho Santa Fe, CA (US); Namal NAWANA, Weston, MA (US)

(21) Appl. No.: 18/071,887

(22) Filed: Nov. 30, 2022

Related U.S. Application Data
(60) Provisional application No. 63/285,029, filed on Dec. 1, 2021.

(51) Int. Cl. B01L 3/00; G01N 1/28

(52) U.S. Cl. CPC B01L 3/502715; G01N 1/286; G01N 2001/2866; B01L 2300/0636; B01L 2200/026; B01L 2300/0681

(57) ABSTRACT

Systems and methods are provided for analyzing a test sample is provided. A system includes an outer container having first and second ends and a base affixed to the first end. The system includes a motorized mixer affixed to the base. The system includes an inner container having first and second ends. The inner container is sized to be received within the outer container. The first end of the inner container has a membrane layer that is pierceable by the mixer when the inner container is received by the outer container to bring the mixer into contact with a test sample in the inner container. The system further includes a test sensor configured for contact with the test sample, and one or more processors for receiving signals from the test sensor following actuation of the mixer to cause mixing of the sample and analyzing the sample based on the signals.

### RELATED APPLICATIONS

This application claims priority to U.S. Provisional Patent Application No. 63/285,029, filed Dec. 1, 2021, entitled “Systems and Methods for Processing and Testing Biological Samples,” which is hereby incorporated by reference in their entirety.

### TECHNICAL FIELD

The present disclosure relates generally to systems and methods for testing biological test samples, and more particularly to a test sampling system configured to collect, process, and test biological samples using a test sensor.

### BACKGROUND

Biological samples provide important information about a variety of physiological conditions. For example, stool testing is a diagnostic technique that can be used to identify a variety of markers, such as hemoglobin proteins and markers of inflammatory conditions, among others. Typically, a patient is required to go to a doctor's office and is subject to an invasive test, such as a colonoscopy, to detect potential illnesses and diseases. Accordingly, there is a need for systems for collecting biological samples as well as systems that allow for rapid testing of the collected samples in a convenient and noninvasive manner

### SUMMARY

The present disclosure is directed to a system for collecting and processing a biological sample and optionally analyzing the processed biological sample to determine whether one or more target analytes are present in the sample. In particular, the present disclosure describes systems and methods for conveniently collecting, processing, and testing a biological sample collected from the user without having to visit a doctor or undergo an invasive procedure. For example, the biological test sample can include or consist of stool, which a user can easily test from home. The disclosed systems and methods identify one or more target analytes (e.g., a particular substance of the test sample under test, such as biological specimens) in the test sample, and present to the user an easily understandable representation of the test results.

In accordance with some embodiments, a test sampling system is provided. In a representative implementation, the test sampling system includes an outer container having first and second ends and a base affixed to the first end. The test sampling system includes a motorized mixer affixed to the base, and an inner container having first and second ends. The inner container is sized to be received within the outer container via the second end thereof. The first end of the inner container has a membrane layer thereacross, the membrane layer being pierceable by the mixer when the inner container is received by the outer container to bring the mixer into contact with a test sample in the inner container. The test sampling system includes a test sensor configured for contact with the test sample. The test sampling system further includes one or more processors for (i) receiving signals from the test sensor following actuation of the mixer to cause mixing of the sample and (ii) analyzing the sample based on the signals.

In some embodiments, the test sample includes a stool sample and a buffer solution. The one or more processors are configured to analyze the test sample only after the mixer has imparted a uniform consistency thereto. In some embodiments, the uniform consistency corresponds to a threshold viscosity.

In some embodiments, the test sensor can detect proteins or fragments of proteins. In some embodiments, the test sensor can detect different forms of nucleic acid (including but not limited to DNA, mRNA, micro-RNA, siRNA). In some embodiments, the test sensor can detect nucleic acid via amplification of specific nucleic acid sequence, or via detection of specific nucleic acid sequences, for instance through hybridization to an oligonucleotide or through a catalytically inactive CRISPR complex with a sgRNA having an oligonucleotide sequence that is complementary with a DNA sequence of interest. In some embodiments, isothermal DNA amplification can be employed to amplify the DNA and hence facilitate genetic screening for biomarkers. In some embodiments, the test sensor is an immuno-assay. In some embodiments, the test sensor can be one of a FET-type device, or electrochemical-type device. In some embodiments, the test sensor is pre-calibrated. In some embodiments, the outer container includes a cavity, and the test sensor is disposed within the cavity. In some embodiments, the test sensor is integral with the one or more processors. In some embodiments, the one or more processors are disposed within the outer container or the base. In some embodiments, the test sampling system includes a display disposed on the outer container or the base. The display, responsive to the one or more processors, presents results of the analysis.

In some embodiments, the outer container further includes a channel and a shield that is disposed adjacent to the channel. In some embodiments, the test sampling system further includes a filter coupled to a channel of the outer container such that unprocessed test sample is prevented from entering the channel. The shield may be configured to prevent the test sample from entering the channel before it is processed. In some embodiments, the shield is mechanically coupled to the motorized mixer such that a position of the shield is changed from a closed position to an open position based on the actuation of the mixer. In some embodiments, the motor is actuated in a first direction to process the test sample and actuated in a second direction to move the processed test sample though a channel of the outer container. In some embodiments, the mixer includes at least two prongs and/or at least two blades.

In some embodiments, the sampling system further includes a lid including a seal housing a buffer solution. In some embodiments, mechanical coupling of the lid to the second end of at least one of the outer container or the inner container causes the seal to break and release the buffer solution into the test sample. In some embodiments, the test sampling system includes a seal adjacent to the membrane layer of the inner container and a buffer solution between the membrane layer and the seal such that, when the outer container receives the inner container, the mixer pierces the membrane layer and seal to release the buffer solution into the test sample.

In accordance with another embodiment, a test sampling system is provided. In this embodiment, the test sampling system includes a base supporting a motor that is coupled to a shaft. The motor is configured to actuate the shaft around a longitudinal axis. The test sampling system includes an outer container including a first end and a second end opposite the first end, the second end configured to receive an inner container and the first end configured to couple to the base. The first end includes an aperture configured to receive a portion of the shaft and a channel configured to receive a processed test sample. The test sampling system includes a mixer configured to couple to the portion of the shaft received via the first end of the outer container. The test sampling system includes an inner container including a first end and a second end opposite the first end, the second end configured to receive a test sample from a user and the first end including a membrane layer. The membrane layer is configured to be pierced by the mixer when the inner container is received by the outer container such that the mixer contacts at least a portion of the test sample. Upon activation of the motor, the mixer in contact with at least the portion of the test sample is actuated to generate the processed test sample based, at least in part, on the test sample and a buffer solution applied to the test sample via the inner container or the outer container, the processed test sample including a uniform consistency. The test sampling system further includes a test sensor fluidically coupled to the channel. The test sensor is configured to receive a portion of the processed test sample and generate information based thereon. The information includes data identifying one or more substances in the portion of the test sample. The test sampling system also includes one or more processors in communication with the test sensor, the one or more processors configured to receive the information from the test sensor and analyze the test sample based on the information.

In accordance with another embodiment, a method of analyzing a test sample is provided. In various embodiments, the method includes providing an outer container including a motorized mixer. The method includes receiving, within the outer container, an inner container including a sample. The inner container has a membrane layer across a first end thereof, whereby the membrane layer is pierced by the mixer to bring the mixer into contact with the test sample. The method includes causing the mixer to impart a uniform consistency to the test sample and thereupon analyzing the test sample.

In accordance with another embodiment, a method of fabricating a test sampling system is provided. The method of fabricating the test sampling system includes providing an outer container having first and second ends and a base affixed to the first end. The method includes providing a motorized mixer affixed to the base. The method also includes providing an inner container having first and second ends. The inner container is sized to be received within the outer container via the second end thereof. The first end of the inner container has a membrane layer thereacross, the membrane layer being pierceable by the mixer when the inner container is received by the outer container to bring the mixer into contact with a test sample in the inner container. The method includes providing a test sensor configured for contact with the test sample and providing one or more processors. The one or more processors are configured for (i) receiving signals from the test sensor following actuation of the mixer to cause mixing of the sample and (ii) analyzing the sample based on the signals.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims.

### BRIEF DESCRIPTION OF THE DRAWINGS

So that the present disclosure can be understood in greater detail, a more particular description may be had by reference to the features of various embodiments, some of which are illustrated in the appended drawings. The appended drawings, however, merely illustrate pertinent features of the present disclosure and are therefore not to be considered limiting, for the description may admit to other effective features as the person of skill in this art will appreciate upon reading this disclosure.

FIGS. 1A and 1B are partially transparent perspective views of a test sampling system, in accordance with some embodiments.

FIG. 2 illustrates an exploded view of a test sampling system, in accordance with some embodiments.

FIGS. 3A-3D illustrate different views of an outer container of the test sampling system, in accordance with some embodiments.

FIG. 4 illustrates a shield, a test sensor, and one or more processors of a test sampling system, in accordance with some embodiments.

FIGS. 5A and 5B illustrate different views of an inner container of the test sampling system, in accordance with some embodiments.

FIG. 6 is a partially transparent perspective view of a base and a motor of a test sampling system, in accordance with some embodiments.

FIGS. 7A and 7B are perspective views illustrating examples of motorized mixers of a test sampling system, in accordance with some embodiments.

FIG. 8 is a flow diagrams illustrating a method of analyzing a test sample, in accordance with some embodiments.

FIG. 9 is another embodiment of the test sampling system, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein in order to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not been described in exhaustive detail so as to avoid obscuring pertinent aspects of the embodiments described herein.

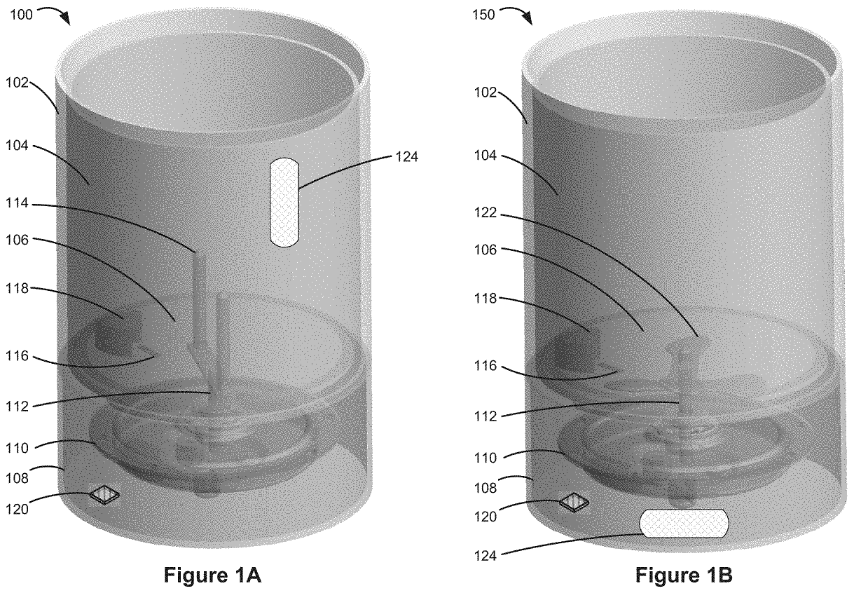

FIGS. 1A and 1B are partially transparent perspective views of a test sampling system, in accordance with some embodiments. In some embodiments, the test sampling system includes an outer container 102, an inner container 104, and a base 108. The outer container 102 has a first end configured to affix to the base 108 and a second end configured to receive the inner container 104. In some embodiments, the outer container 102 supports a shield 118 and a test sensor 116. The base 108 supports a motor 110 that is coupled to a shaft 112. The motor 110 configured to actuate the shaft 112 around a longitudinal axis. The shaft 112 can be coupled to a mixer, which may utilize two or more prongs 114 or two or more blades 122 as mixing members. The mixer, when actuated, processes a test sample (e.g., mixes the test sample). For purposes of this disclosure, the motor 110, the shaft 112, and the mixing members are referred to as a motorized mixer. In some embodiments, the motor 110 actuates the shaft 112 and mixer in one or more directions.

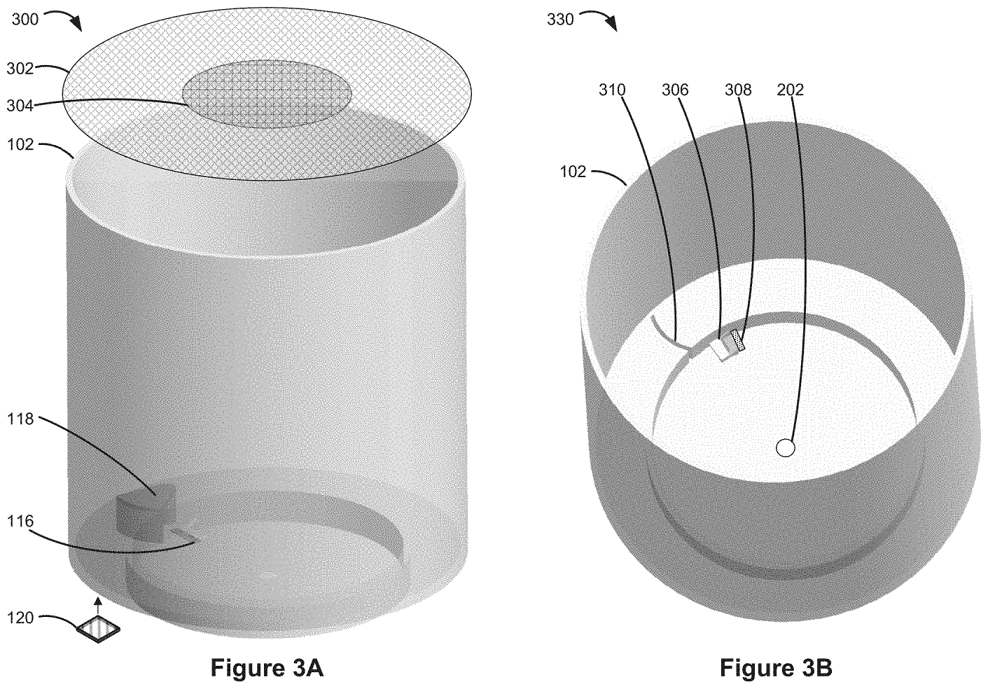

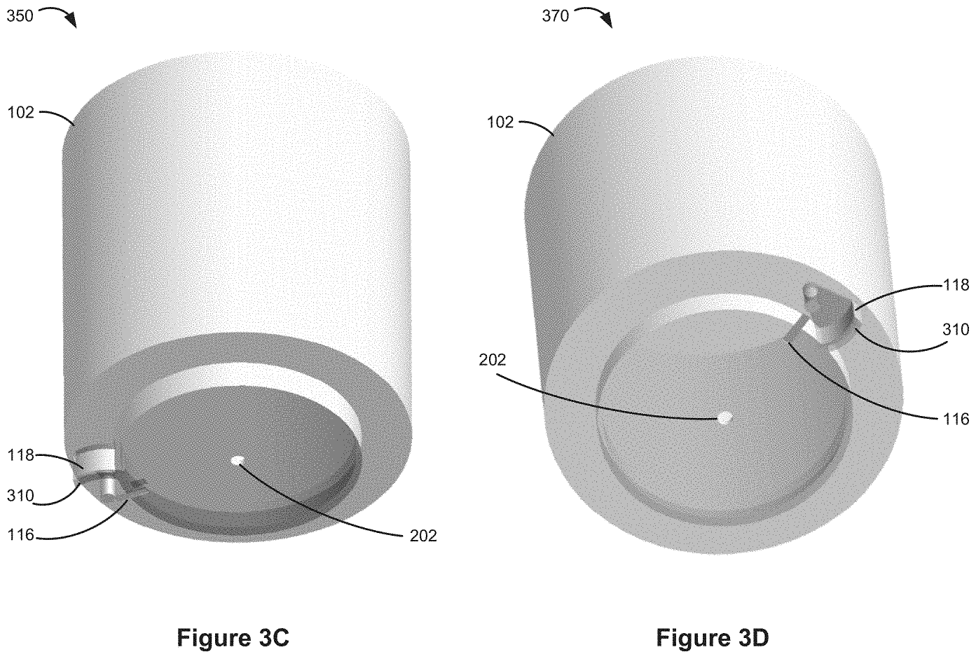

A test sample, for purposes of this disclosure, includes a stool sample and a buffer solution (e.g., buffer solution 304; FIG. 3A). In some embodiments, the outer container 102 or the base 108 support one or more processors 120 (e.g., the one or more processors 120 can be disposed within the outer container 102 or the base 108). The one or more processors 120 are communicatively coupled to the test sensor 116. The inner container 104 has a first end and a second end. The first end of the inner container 104 has a membrane layer 106 thereacross and the second end of the inner container 104 has an opening to receive a test sample from a user. The inner container 104 is sized to be received within the outer container 102 (via the inner container 102's second end). The membrane layer 106 is pierceable by the mixer when the inner container 104 is received by the outer container 102 such that the mixer is brought into contact with the test sample in the inner container 104.

The test sampling system is configured to process the test sample until the test sample obtains a uniform consistency such that the processed test sample can be analyzed by the test sensor 116 and the one or more processors 120 of the test sampling system. In some embodiments, the uniform consistency corresponds to a current draw of test sampling system (e.g., a measured electrical current is below an electrical current threshold, which indicates that a uniform consistency is achieved). Alternatively or additionally, in some embodiments, the uniform consistency corresponds to a threshold viscosity (e.g., a determined viscosity is below a threshold viscosity, which indicates that a uniform consistency is achieved). In some embodiments, a viscosity of the processed test sample is determined based, at least in part, on a current draw of test sampling system. In some embodiments, the test sensor 116 is configured to contact the processed test sample and generate information based thereon. The information includes data identifying one or more substances in the test sample. The one or more processors 120 receive signals (including the generated information) from the test sensor 116 following actuation of the mixer (which causes mixing of the test sample) and analyze the test sample based on the signals. In some embodiments, the test sampling system includes an interface 124 (such as a touch display, one or more buttons, light sources, etc.) disposed on an external portion of the outer container 102 or the base 108.

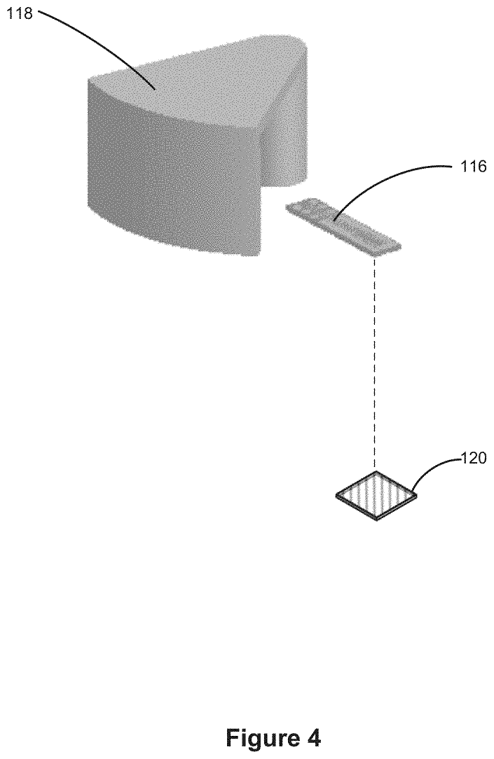

The interface 124 is configured to present results of the analysis (determined by the test sensor 116 and the one or more processors 120 as discussed below in reference to FIG. 4) to the user. The interface 124 includes one or more of a display, one or more buttons, and/or one or more light sources (e.g., light emitting diodes). In some embodiments, the interface 124 receives, from the one or more processors 206, a determined test analysis and presents the determined test analysis to the user. In some embodiments, the interface 124 illuminates a positive or negative sign using a light emitting diode or other illumination source to indicate a positive or negative test result. In other embodiments, the interface 124 displays a numeric or alphanumeric result indication. In some embodiments, the interface 124 receives one or more inputs from a user, such as actuation of one or more buttons (e.g., surfaces that can be depressed or touch surfaces that can be selected by a user to turn the device on, off, initiate a test, etc.). In some embodiments, the test sampling system can be coupled to a remote digital data processor, e.g., a smart phone, tablet, computer, network, etc., and can communicate results and/or receive inputs via a wired or wireless connection to the remote digital data processor. For example, in one embodiment the test sampling system can be coupled to a smart phone or other external device via a Bluetooth wireless connection using a wireless communication interface included in the device. Test results can be communicated to, and displayed by, the remote digital data processor.

A first embodiment 100 of the test sampling system includes two or more prongs 114 coupled to the shaft 112 and the motor 110, and the interface 124 disposed on an external portion of the outer container 102. A second embodiment 150 of the test sampling system includes two or more blades 122 coupled to the shaft 112 and the motor 110, and the interface 124 disposed on an external portion of the base 108.

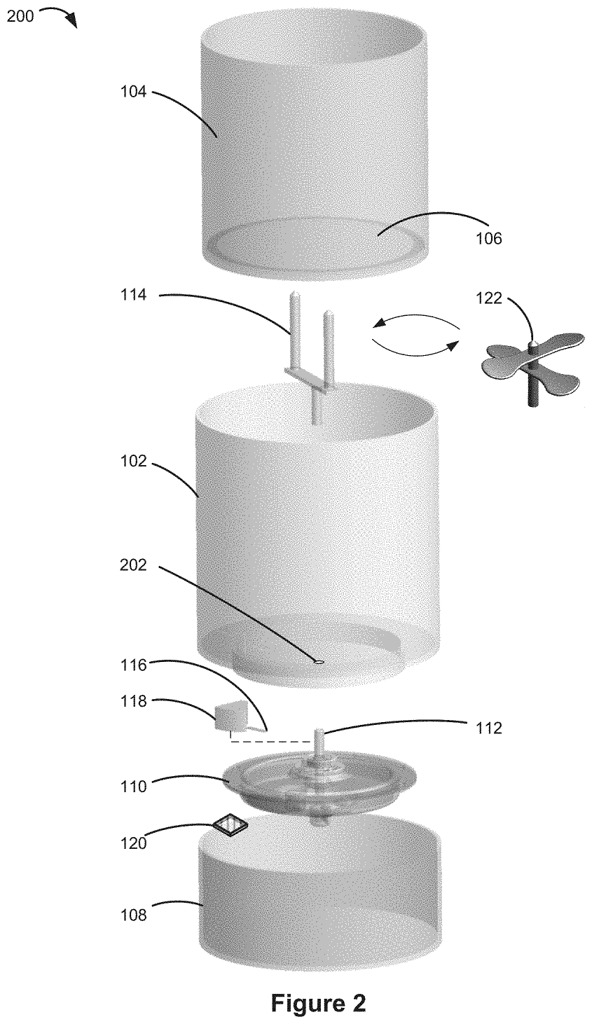

FIG. 2 illustrates an exploded view of a test sampling system, in accordance with some embodiments. The exploded view 200 of the test sampling system includes an outer container 102, an inner container 104, a membrane layer 106, a base 108, a motor 110, a shaft 112, a mixer (e.g., two or more prongs 114 or two or more blades 122), a test sensor 116, a shield 118 and/or one or more processors 120 as described above in reference to FIGS. 1A and 1B.

As shown in exploded view 200, in some embodiments, the motor 110 is coupled to the shield 118. The shield 118 can move from a closed position to an open position based on actuation of the motor 110. In some embodiments, the shaft 112 (which is coupled to or is part of the motor 110) is configured to be received by the outer container 102 via an aperture 202 disposed at the first end of the outer container 102. In some embodiments, the mixer is configured to couple to the portion of the shaft 112 received via the outer container 102. The mixer attached to the portion of the shaft 112 can be swapped by the user. For example, as shown in exploded view 200, the user can switch between the two or more prongs 114 and the two or more or blades 122.

In some embodiments, the shield 118 and the test sensor 116 are disposed within a cavity of the outer container 102. Alternatively, in some embodiments, the test sensor 116 is coupled to the base 108. In some embodiments, the test sensor 116 is integral with the one or more processors 120. The test sensor 116 is fluidically coupled to an opening of the outer container 102 such that, when the shield 118 is in an open position, the test sample contacts a portion of the test sensor 116. The shield 118 is in the open position when the mixer is inactive and in a closed position when the mixer is active. Additional detail information on the opening and closing of the shield 118 is provided below in reference to FIG. 4.

FIGS. 3A-3D illustrate different views of an outer container of the test sampling system, in accordance with some embodiments. A first view 300 shows a perspective view of the outer container 102, a second view 330 shows the inside of the outer container 102, a third view 350 illustrates a first bottom view of the outer container 102, and a fourth view 370 illustrates a second bottom view of the outer container 102.

As shown in the first view 300, the outer container 102 includes a shield 118 and a test sensor 116. In some embodiments, the shield 118 and the test sensor 116 are disposed within a cavity of the outer container 102. Alternatively, in some embodiments, the test sensor 116 is disposed at an exterior portion of the outer container 102 that is fluidically coupled to a portion of the outer container 102 that contacts a processed test sample. The shield 118 is configured to prevent an unprocessed test sample from contacting the test sensor 116. In some embodiments, one or more processors are disposed within the cavity of the outer container 102. Alternatively, in some embodiments, the one or more processors 120 are disposed at an exterior portion of the outer container 102. In some embodiments, the outer container 102 prevents the test sample from contacting the one or more processors 120.

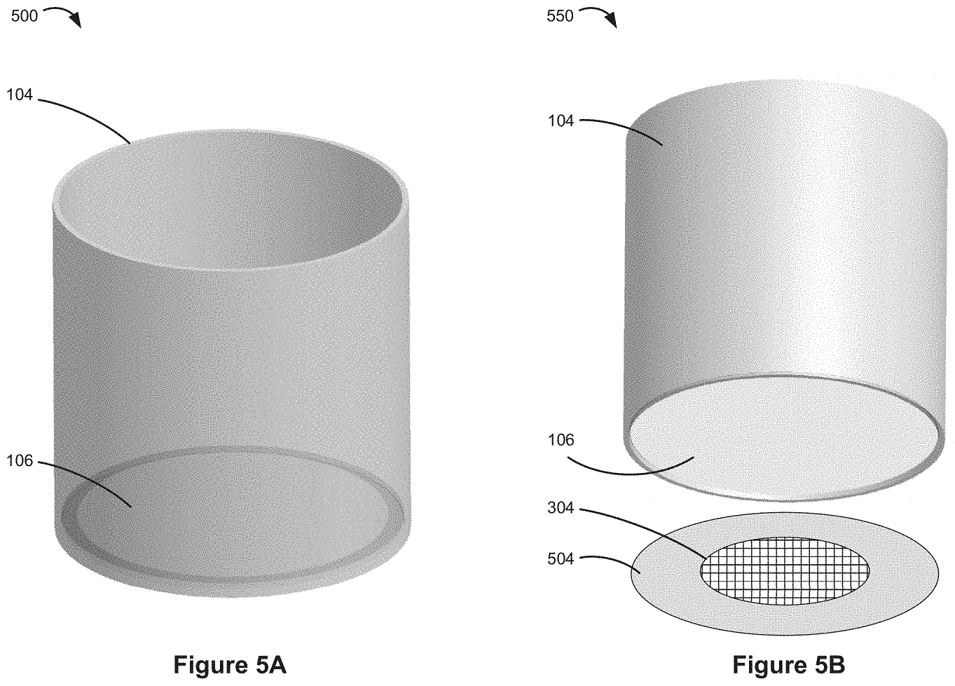

In some embodiments, the test sampling system includes a lid 302 that is configured to mechanically couple to the outer container 102, the inner container 104 (FIGS. 1A and 1B), or both. In some embodiments, the lid 302 includes a seal 504 (FIG. 5B) that is configured to be pierced when the lid 302 is mechanically coupled to the outer container 102, the inner container 104, or both. The seal 504 retains a buffer solution 304 that is applied to a stool sample to process a test sample. In some embodiments, the buffer solution 304 is a liquid reagent or aqueous buffer for dissolving the stool sample. For example, in some embodiments, the buffer solution is a phosphate buffer. In some embodiments, 1 g stool/25 ml of phosphate buffer is applied to the stool sample. In some embodiments, the buffer solution 304 is a lysis/binding buffer containing denaturing agents, such as chaotropic salts and proteinase K, that can be employed to release proteins or nucleic acids. In some such embodiments, the buffer solution 304 can also bind and stabilize the released molecules (e.g., nucleic acid, proteins).

In the second view 330, the outer container 102 includes an aperture 202, a channel 306, a filter 308, and a shield guide 310. As described above in reference to FIG. 2, the aperture 202 is configured to receive a portion of a shaft 112 coupled to a motor 110 such that a user can couple different mixers (e.g., two or more prongs 114 and two or more or blades 122; FIG. 1) to the portion of the shaft 112 as desired. In some embodiments, the channel 306 is configured to transfer a processed test sample within the outer container 102 to the test sensor 116. In some embodiments, the channel only allows a fluid (e.g., a processed test solution) to enter in a single direction (e.g., flow moving in a counterclockwise direction). In some embodiments, the channel 306 includes a filter 308 that prevents unprocessed test samples or solid matter from entering the channel 306. In some embodiments, the shield 118 is disposed adjacent to the channel 306. In some embodiments, the shield 118 is configured to move along a shield guide 310. The shield guide 310 controls or restricts the movement of the shield 118 as it moves from a closed position to an open position (as described below in reference FIG. 4). The shield 118 covers the test sensor 116 while the test sample is unprocessed (preventing the test sample from contacting the test sensor 116) and retracts (i.e., move to an open position) to allow a processed test sample to contact the test sensor 116.

The third view 350 and the fourth view 370 provide different bottom views of the shield guide 310, the shield 118, the test sensor 116, and the aperture 202. As shown in the third view 350 and the fourth view 370, the test sensor 116 can be disposed at an exterior portion of the outer container 102 that is in fluidic contact with a portion of the outer container 102 in contact with a processed test sample (e.g., the channel 306). In some embodiments, when the shield 118 is in the open position, the shield 118 rests in an exterior portion of the outer container 102.

FIG. 4 illustrates a shield, a test sensor, and one or more processors of a test sampling system, in accordance with some embodiments. The shield 118, the test sensor 116, and the one or more processors 120 work in conjunction to analyze a processed test sample. In embodiments, the shield 118 is configured to prevent an unprocessed test sample from contacting the test sensor 116. The test sensor 116 and the one or more processors 120 are configured to analyze the test sample only after the motorized mixer has imparted a uniform consistency on the test sample.

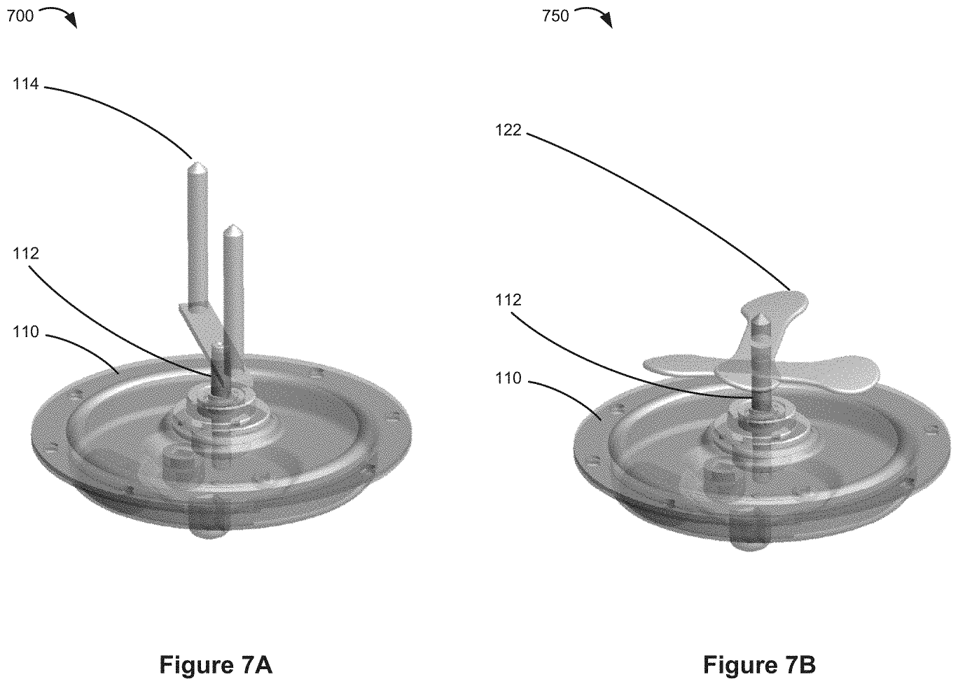

In some embodiments, as described above in reference to FIG. 2, the shield 118 is (mechanically) coupled to the motor 110. In some embodiments, the motor causes the shield 118 to move from a closed position (preventing the test solution from contacting the test sensor 116) to an open position (enabling the processed test sample to contact the test sensor 116). For example, while the motorized mixer is active (i.e., actuating the mixer in a first direction), the motorized mixer can cause the shield 118 to be in a closed position, and, when the motorized mixer is inactive or configured to actuate in a second direction (opposite the first direction), the motorized mixer can cause the shield 118 move into an open position. Alternatively, in some embodiments, the shield 118 is moved from a closed position to an open position based on a flow direction of the test sample (without being coupled to the motor 110). For example, the motorized mixer, when processing the test sample, actuates in a first direction and causes the test sample to flow in the first direction (which causes the shield 118 to remain closed); and, when the test sample is fully processed (e.g., satisfies a minimum viscosity threshold), the motorized mixer actuates in a second direction and causes the test sample to flow in the second direction opposite the first (which causes the shield 118 to open). In some embodiments, the shield is coupled to a separate motor controlled by the one or more processors 120 that is caused to move from the closed position to the open position based on a determination (by the one or more processors 120) that the motorized mixer imparted a uniform consistency on the test sample (as discussed in detail below in reference to FIGS. 7A and 7B).

The test sensor 116 receives a portion of the test sample from the inner container 104. For example, the test sensor 116 can be fluidically coupled to a portion of the outer container 102 that makes fluid contact with a processed test sample that enters the outer container 102 when the motorized mixer pierces the membrane layer 106 of the inner container 104 and processes the test sample. In some embodiments, the test sensor 116 can be fluidically coupled to channel 306 of the outer container 102 that makes fluid contact with a processed test sample that enters the outer container 102 when the motorized mixer pierces the membrane layer 106 of the inner container 104 and processes the test sample. In some embodiments, the test sensor 116 is disposed within the outer container 102 or a base 108 (FIGS. 1A and 1B). In some embodiments, the test sensors are pre-calibrated (e.g., calibrated during manufacturing).

The test sensor 116, upon receiving the portion of the processed test sample from the outer container 102, generates information (based on the portion of the test sample) including data identifying one or more substances in the portion of the test sample, such as biomarkers associated with colorectal cancer. For example, the test sensor 116 (e.g., an antibody-functionalized graphene layer) can measure, monitored, and analyzed an electrical resistance to determine whether one or more substances with a concentration above a predefined threshold is present in the test sample. For example, a change in the DC resistance of the test sensor 116 above a predefined threshold can be correlated with the detection of one or more substances in the test solution. In some embodiments, the test sensor 116 is one of a FET-type device, a ChemFET-type device, EChemFET-type device, or electrochemical-type device. In some embodiments, the test sensor is an immuno-assay. In some embodiments, isothermal DNA amplification can be employed to amplify the DNA and hence facilitate genetic screening for biomarkers. In some embodiments, the test sensor can detect proteins or fragments of proteins. In some embodiments, the test sensor can detect different forms of nucleic acid (including but not limited to DNA, mRNA, micro-RNA, siRNA). In some embodiments, the test sensor can detect nucleic acid via amplification of specific nucleic acid sequence, or via detection of specific nucleic acid sequences, for instance through hybridization to an oligonucleotide or through a catalytically inactive CRISPR complex with a sgRNA having an oligonucleotide sequence that is complementary with a DNA sequence of interest.

Further details regarding the test sensor 116 and various detection methodologies that can be employed in connection with the test sampling system disclosed herein can be found in the following patents and published applications: U.S. Pat. No. 9,664,674, entitled “Device and Method for Chemical Analysis;” US Pat. Pub. No. 20 19/0079068, entitled “Device and Method for Chemical Analysis;” US Pat. Pub. No. 2019/0284615, entitled “Methods and Devices for Detection of Pathogens;” US Pat. Pub. No. 2020/00 11860, entitled “Functionalized Sensor for Detection of Biomarkers;” U.S. Pat. No. 10,782,285, entitled “Device and Method for Chemical Analysis;” and US Pat. Pub. No. 2020/03 00845, entitled “Methods and Devices for Detection of THC.” The entire contents of each of these publications is hereby incorporated by reference herein.

The test sensor 116 is in communication with the one or more processors 120. The test sensor 116 is configured to provide the one or more processors 120 one or more signals. The one or more signals including the generated information by the test sensors 116. In some embodiments, the test sensor 116 is in communication with the one or more processors 120 via wireless or wired connection. For example, the test sensor 116 can be coupled to the one or more processors 120 via a ribbon cable, USB, or other connecting element. In some embodiments, the test sensor 116 is integral with the one or more processors 120. Alternatively, the test sensor 116 can be communicatively coupled to the one or more processors 206 via Bluetooth or other wireless protocol.

The one or more processors 120 are disposed within a portion of the outer container 102 or the base 108. In some embodiments, the one or more processors 120 are configured to analyze the signals (or generated information) received from the test sensor 116. The one or more processors 120 are configured to determine whether one or more target analytes of interest (e.g., one or more pathogens) are present in the test sample. In general, instructions for analyzing the signals received by the one or more processors 120 can be implemented in hardware, firmware, and/or software using techniques known in the art as informed by the present teachings. In some embodiments, the one or more instructions are stored in a computer memory or computer-readable storage medium coupled to the one or more processors 120.

In some embodiments, the one or more processors 120 are coupled to the printed circuit board (not show) on which electronic circuitry is disposed. The one or more processors 120 and the electric circuitry disposed on the printed circuit board are powered by the internal power source (e.g., batteries) or an external power source (e.g., AC Mains). In some embodiments, the one or more processors 120 are communicatively coupled to the interface 124. In some embodiments, the interface 124 is powered by the internal power source or the external power source.

FIGS. 5A and 5B illustrate different views of an inner container of the test sampling system, in accordance with some embodiments. FIG. 5A shows a first view 500 of the inner container 104. The inner container 104 has first and second ends and is sized to be received by the outer container 102 (FIGS. 1A and 1B). The first end of the inner container 104 includes a membrane layer 106 thereacross. The inner container 104 is configured to receive a stool sample from the user. The stool sample rests on the membrane layer 106 of the inner container 104. The inner container 104 is further configured to receive a buffer solution 304 (FIG. 3A). The membrane layer 106 is pierceable by a mixer (e.g., two or more prongs 114 and two or more or blades 122; FIGS. 1A and 1B) when the inner container 104 is received by the outer container 102 to bring the mixer into contact with a test sample in the inner container 104.

FIG. 5B illustrates a bottom view 550 of the inner container 104. In some embodiments, the inner container 104 further includes a seal 504 adjacent to the membrane layer 106. In some embodiments, the buffer solution 304 is stored between the seal 504 and the membrane layer 106 such that, when the outer container 102 receives the inner container 104, the mixer pierces the membrane layer 106 and the seal 504 releasing the buffer solution 304 onto the stool sample (resulting in the test sample).

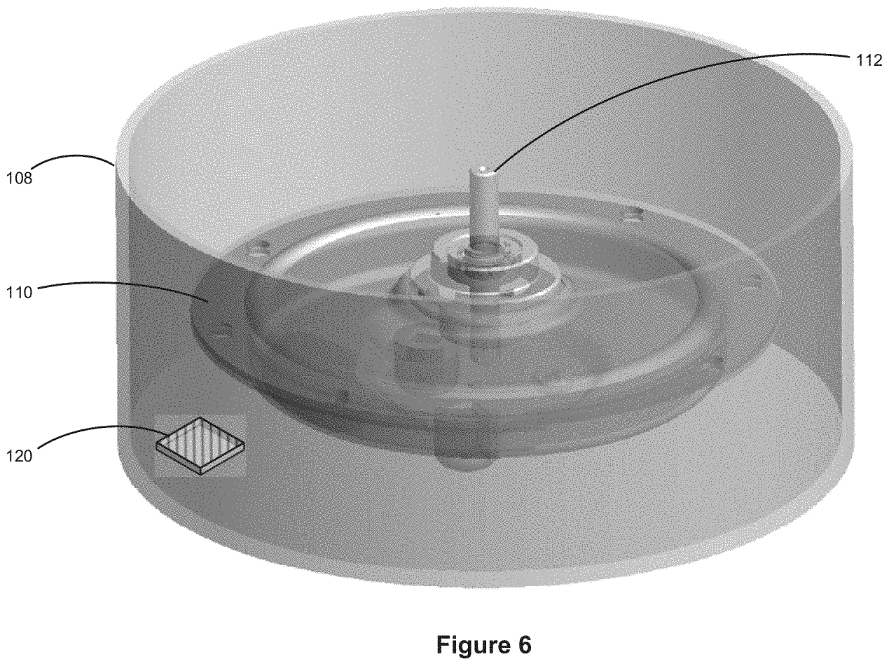

FIG. 6 is a partially transparent perspective view of a base and a motor of a test sampling system, in accordance with some embodiments. The motor 110 may be affixed to the base 108. The base 108 may house the motor 110 such that the test sample does not contact the motor 110 (with the exception of the mixer, such as the two or more prongs 114 and two or more or blades 122 (FIGS. 1A and 1B)). Similarly, in some embodiments, the base 108 houses one or more processors 120 such that the test sample does not contact the one or more processors 120. As described above in reference to FIG. 4, in some embodiments, a test sensor 116 is integral with the one or more processors 120 and a channel from the outer container 102 fluidically couples the outer container 102 to the test sensor 116 such that the processed test sample makes contact with the test sensor 116. The motor 110 includes a shaft 112 that is configured to couple to one or more mixers as descried below in reference to FIGS. 7A and 7B.

FIGS. 7A and 7B are perspective views illustrating examples of motorized mixers of a test sampling system, in accordance with some embodiments. A first embodiment of a motorized mixer 700 includes a motor 110, a shaft 112 coupled to the motor 110, and two or more prongs 114 coupled to the shaft. As described above in reference to FIG. 6, the motorized mixer can be affixed to the base 108. A second embodiment of a motorized mixer 750 includes the motor 110, the shaft 112 coupled to the motor 110, and two or more or blades 122 coupled to the shaft. Similar to the first embodiment of the motorized mixer 700, the second embodiment of the motorized mixer 750 can be affixed to the base 108.

As described above in reference to FIGS. 1A and 1B, the motorized mixer actuates the shaft 112 and mixer (e.g., the two or more prongs 114 or two or more or blades 122) around a longitudinal axis. In some embodiments, the motorized mixer actuates the shaft 112 and mixer in at least two directions (e.g., a clockwise and counterclockwise direction). In some embodiments, the motorized mixer is actuated at one or more speeds (e.g., low, medium, or high). In some embodiments, the motorized mixer is actuated in response to user input via the interface 124 (FIGS. 1A and 1B). For example, the user can actuate one or more buttons or input one or more inputs via a touch display that cause the motorized mixer to actuate. Alternatively, or additionally, in some embodiments, the test sampling system can be coupled to a remote digital data processor (e.g., a smart phone, tablet, computer, network, etc.) that provides one or more commands to test sampling system that cause the motorized mixer to actuate.

In some embodiments, the motorized mixer is configured to continue to actuate until a test sample is fully processed (e.g., a uniform consistency is imparted on the stool sample and the buffer solution 304 (FIG. 3A) mixture). In some embodiments, the one or more processors 120 determine a viscosity of the stool sample and the buffer solution 304 mixture (i.e., the test sample) and (automatically) cease actuation of the motorized mixer when a threshold viscosity satisfied. In some embodiments, the one or more processors 120 determine a viscosity of the test sample mixture based on the motorized mixer power consumption, speed of the motorized mixer, resistance against the motorized mixer, and/or data from one or more sensors. In some embodiments, operation of the motorized mixer is ceased after the motorized mixer has been actuated for a predetermined amount of time (e.g., 30 sec, 1 min, 3 min, etc.). Alternatively, or additionally, in some embodiments, the operation of the motorized mixer is ceased in response to user input via the interface 124 or one or more commands provided by the remote digital data processor. In some embodiments, after the motorized mixer fully processes the test sample, the motor 110 move the shield 118 (FIGS. 1A and 1B) into an open position such that the processed test sample contacts the test sensor 116 (FIGS. 1A and 1B). Alternatively, or additionally, in some embodiments, after the motorized mixer fully processes the test sample, the motorized mixer is actuated in an opposite direction such that the shield 118 is moved into an open position and/or the processed test sample is guided to the test sensor 116 (and, in some embodiments, though the channel 306) as described above in reference to FIGS. 3A-3D.

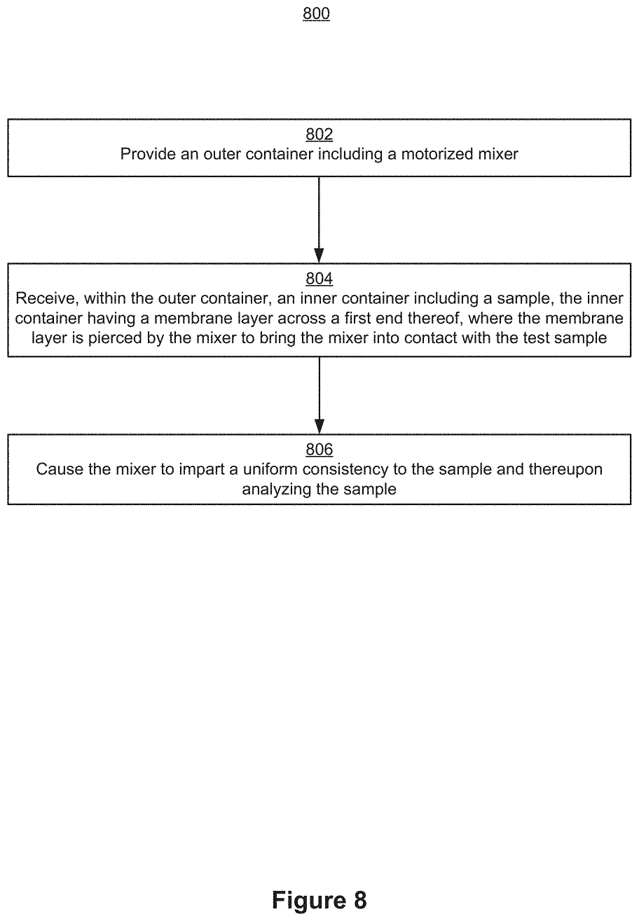

FIG. 8 is a flow diagram illustrating a method of analyzing a test sample, in accordance with some embodiments. Operations (e.g., steps) of the method 800 may be performed by one or more processors 120 (FIGS. 1A and 1B) of a test sampling system (e.g., systems 100 and 150; FIGS. 1A and 1B). At least some of the operations shown in FIG. 8 correspond to instructions stored in a computer memory or computer-readable storage medium. Operations 802-806 can also be performed in part using one or more processors and/or using instructions stored in memory or computer-readable medium of a computing device (such as a smart phone, tablet, computer, etc. that can perform operations 802-806 alone or in conjunction with the one or more processors of the test sampling system 100 and 150 (FIGS. 1A and 1B)).

In some embodiments, the method 800 includes providing (802) an outer container including a motorized mixer. The method 800 includes receiving (804), within the outer container, an inner container including a sample, the inner container having a membrane layer across a first end thereof, whereby the membrane layer is pierced by the mixer to bring the mixer into contact with the test sample. For example, as shown in FIGS. 1A and 1B, the motorized mixer in the outer container 102 pierces a membrane layer 106 of the inner container 104 such that the motorized mixer contacts a test sample within the inner container 104 and the test sample has access to the outer container 102. The method 800 further includes causing (806) the mixer to impart a uniform consistency to the sample and analyzing, by the test sensors 116 and the one or more processors 120, the test sample.

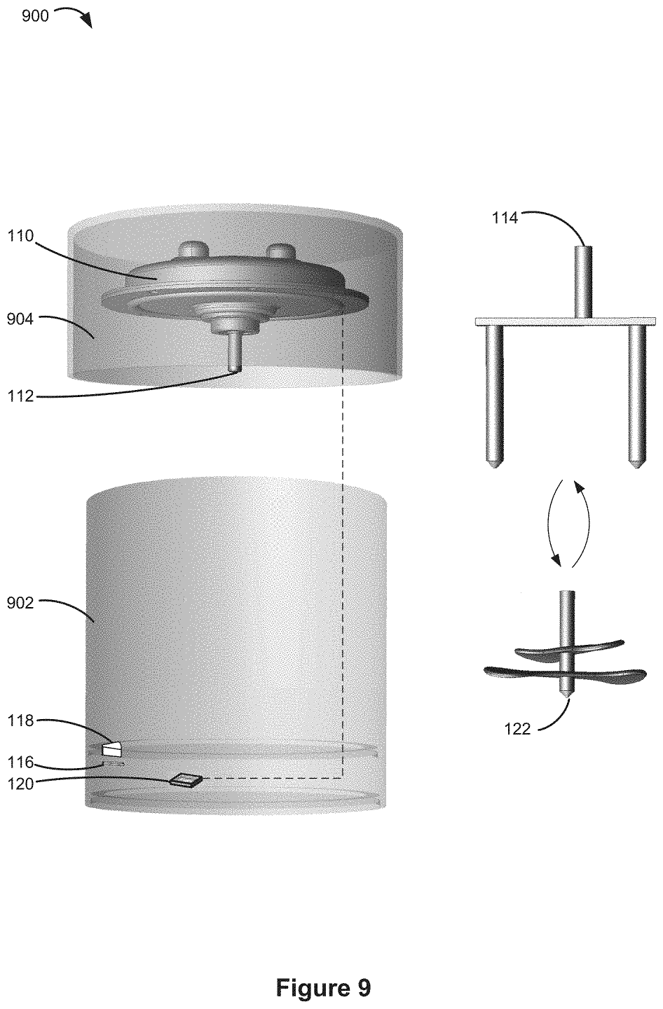

FIG. 9 is another embodiment of the test sampling system, in accordance with some embodiments. The other embodiment of the test sampling system is a motorized top test sampling system 900. The motorized top test sampling system 900 includes a collection container 902 and a top 904. The collection container 902 houses a shield 118, a test sensor 116, and one or more processors 120. The shield 118, the test sensor 116, and the one or more processors 120 perform one or more functions as described above in reference to FIGS. 1A-8. The top 904 includes a motor 110 coupled to a shaft 112. As described above, in reference to FIGS. 1A-8, the motor 110 is configured to actuate the shaft 112 around a longitudinal axis to processes a test sample (using two or more prongs 114 or two or more blades 122) within the collection container 902. Similar to the test sampling systems described above in reference to FIGS. 1A-8, the motorized top test sampling system 900 is configured to generate information (based on a portion of the test sample) including data identifying one or more substances in the test sample.

In some embodiments, the top 904 is configured to couple to the collection container 902. The top 904 couples to the collection container 902 such that the contents (i.e., the test sample) of the collection container 902 do not escape the collection container 902 during the processing of the test sample. Additionally, the top 904, when coupled to the collection container 902, reduces or eliminates the chances of the top coming lose or falling from the collection container 902. The motorized top test sampling system 900 provides another test sampling system with less components.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A test sampling system comprising:
an outer container having first and second ends and a base affixed to the first end;
a motorized mixer affixed to the base;
an inner container having first and second ends, the inner container being sized to be received within the outer container via the second end thereof, the first end of the inner container having a membrane layer thereacross, the membrane layer being pierceable by the mixer when the inner container is received by the outer container to bring the mixer into contact with a test sample in the inner container;
a test sensor configured for contact with the test sample; and
one or more processors for (i) receiving signals from the test sensor following actuation of the mixer to cause mixing of the sample and (ii) analyzing the sample based on the signals.

2. The test sampling system of claim 1, wherein the test sample includes a stool sample and a buffer solution, the one or more processors being configured to analyze the test sample only after the mixer has imparted a uniform consistency thereto.

3. The test sampling system of claim 1, further comprising a display disposed on the outer container or the base and responsive to the one or more processors, the display being configured to present results of the analysis.

4. The test sampling system of claim 1, wherein the one or more processors are disposed within the outer container or the base.

5. The test sampling system of claim 1, wherein the outer container further includes a channel and a shield that is disposed adjacent to the channel, wherein the shield is configured to prevent the test sample from entering the channel before it is processed.

6. The test sampling system of claim 5, wherein the shield is mechanically coupled to the motorized mixer such that a position of the shield is changed from a closed position to an open position based on the actuation of the mixer.

7. The test sampling system of claim 1, wherein the test sensor is one of a ChemFET-type device, EChemFET-type device, immuno-assay, or electrochemical-type device.

8. The test sampling system of claim 1, wherein the test sensor is configured to detect proteins or fragments of proteins.

9. The test sampling system of claim 1, wherein the test sensor is configured to detect nucleic acid via amplification of specific nucleic acid sequence or via detection of specific nucleic acid sequences.

10. The test sampling system of claim 1, the test sensor is configured to perform isothermal DNA amplification that is used for detecting the signals based on the test sample.

11. The test sampling system of claim 1, wherein the mixer includes at least two prongs.

12. The test sampling system of claim 1, wherein the mixer includes at least two blades.

13. The test sampling system of claim 1, wherein the outer container includes a cavity and the test sensor is disposed within the cavity.

14. The test sampling system of claim 1, wherein the test sensor is integral with the one or more processors.

15. The test sampling system of claim 1, further comprising a lid including a seal housing a buffer solution, mechanical coupling of the lid to the second end of at least one of the outer container or the inner container causing the seal to break and release the buffer solution into the test sample.

16. The test sampling system of claim 1, further comprising a seal adjacent to the membrane layer of the inner container and a buffer solution between the membrane layer and the seal such that, when the outer container receives the inner container, the mixer pierces the membrane layer and the seal to release the buffer solution into the test sample.

17. The test sampling system of claim 1, further comprising a filter coupled to a channel of the outer container such that unprocessed test sample is prevented from entering the channel.

18. The test sampling system of claim 1, wherein the motor is actuated in a first direction to process the test sample and actuated in a second direction to move the processed test sample though a channel of the outer container.

19. A test sampling system comprising:
a base supporting a motor that is coupled to a shaft, wherein the motor is configured to actuate the shaft around a longitudinal axis;
an outer container including a first end and a second end opposite the first end, the second end configured to receive an inner container and the first end configured to couple to the base, wherein the first end includes an aperture configured to receive a portion of the shaft and a channel configured to receive a processed test sample;
a mixer configured to couple to the portion of the shaft received via the first end of the outer container;
an inner container including a first end and a second end opposite the first end, the second end configured to receive a test sample from a user and the first end including a membrane layer, wherein the membrane layer is configured to be pierced by the mixer when the inner container is received by the outer container such that the mixer contacts at least a portion of the test sample;
wherein, upon activation of the motor, the mixer in contact with at least the portion of the test sample is actuated to generate the processed test sample based, at least in part, on the test sample and a buffer solution applied to the test sample via the inner container or the outer container, the processed test sample including a uniform consistency;
a test sensor fluidically coupled to the channel, wherein the test sensor is configured to receive a portion of the processed test sample and generate information based thereon, the information including data identifying one or more substances in the portion of the test sample; and
one or more processors in communication with the test sensor, the one or more processors configured to receive the information from the test sensor and analyze the test sample based on the information.

20. A test sampling method comprising:
providing an outer container including a motorized mixer;
receiving, within the outer container, an inner container including a sample, the inner container having a membrane layer across a first end thereof, whereby the membrane layer is pierced by the mixer to bring the mixer into contact with the test sample; and
causing the mixer to impart a uniform consistency to the test sample and thereupon analyzing the test sample.
